(19) United States
(12) Patent Application Publication
(10) Pub. No.: US 2015/0381658 A1
(43) Pub. Date: Dec. 31, 2015

(54) PREMISES-AWARE SECURITY AND POLICY ORCHESTRATION

(71) Applicant: McAfee, Inc., Santa Clara, CA (US)

(72) Inventors: Rajesh Poornachandran, Portland, OR (US); Shahrokh Shahidzadeh, Portland, OR (US); Sudeep Das, Cupertino, CA (US); Vincent J. Zimmer, Federal Way, WA (US); Sumant Vashisth, Portland, OR (US); Pramod Sharma, Beaverton, OR (US)

(73) Assignee: McAfee, Inc., Santa Clara, CA (US)

(21) Appl. No.: 14/560,141

(22) Filed: Dec. 4, 2014

Related U.S. Application Data
(63) Continuation-in-part of application No. 14/320,505, filed on Jun. 30, 2014.

(51) Int. Cl. H04L 29/06; H04W 4/02; H04W 12/08; H04W 4/00; H04W 12/06

(52) U.S. Cl. CPC H04L 63/20; H04W 4/008; H04W 4/005; H04W 12/06; H04W 12/08; H04L 63/0876; H04W 4/021; H04L 63/108

(57) ABSTRACT

A tracking station detects a mobile data processing system (DPS) within communication range of a short range wireless module of the tracking station. In response to detecting the mobile DPS, the tracking station obtains identification data for the mobile DPS from a security module of the mobile DPS. The tracking station uses the identification data to obtain credentials to access secure storage on the mobile DPS. The tracking station automatically generates security configuration data for the mobile DPS, based on multiple factors pertaining to the mobile DPS, such as identity of the mobile DPS, a location of the mobile DPS, capabilities of the mobile DPS, etc. The tracking station uses the credentials to write the security configuration data to the secure storage of the mobile DPS. The security configuration data calls for the mobile DPS to automatically disable or enable at least one component. Other embodiments are described and claimed.

### TECHNICAL FIELD

Embodiments described herein relate generally to data processing and in particular to premises-aware security and policy orchestration for data processing systems.

### BACKGROUND

Different departments within a company may be located at different locations within a building. Employees with mobile data processing systems may visit different departments at different times. The management of the company may want to enforce a different security policy for data processing systems operating in each different location. For instance, the management may want to enforce a relatively open security policy in the first floor, an intermediate security policy on the second floor, and a strict security policy on the top floor.

However, it may be difficult or impossible to orchestrate such security policies using conventional approaches to computer security, particularly when data processing systems may be moved from location to location.

The present disclosure describes methods and apparatus which utilize premises awareness to orchestrate and enforce a multi-faceted security policy.

### BRIEF DESCRIPTION OF THE DRAWINGS

FIG. 1 is a schematic diagram of an example premises-aware security system.

FIG. 2 is a block diagram of an example data processing system with premises-aware security.

FIGS. 3A and 3B present a flowchart of an example process for using premises-aware security.

FIGS. 4A and 4B present another flowchart of an example process for using premises-aware security.

### DESCRIPTION OF EMBODIMENTS

As indicated above, the present disclosure describes methods and apparatus which utilize premises awareness to orchestrate and enforce a multi-faceted security policy. As described in greater detail below, a person with a mobile data processing system may travel from location to location within a building, and the data processing system may automatically enforce different security restrictions in each different location. For purposes of this disclosure, the ability to automatically enforce different security restrictions for a data processing system when the data processing system is used in different locations may be referred to as premises-aware security (PAS). Furthermore, PAS may implement security policies based on combinations of two or more factors, including attributes such as device location, device capabilities, user identity and/or user credentials, etc.

A typical conventional approach to location-based security (LBS) depends upon a trustworthy network. However, conventional networks may not always be secure. For instance, an organization's network security may be breached by worms, viruses, and the like, particularly when the network is not limited to use by data processing systems provided by the organization, but is instead configured to allow users to utilize their own devices on the network. By contrast, the present disclosure describes an approach to LBS that, in at least one embodiment, ensures that client systems adhere to prescribed security policies even if network security has been compromised.

For purposes of illustration, the present disclosure describes one or more example embodiments. However, the present teachings are not limited to those particular embodiments.

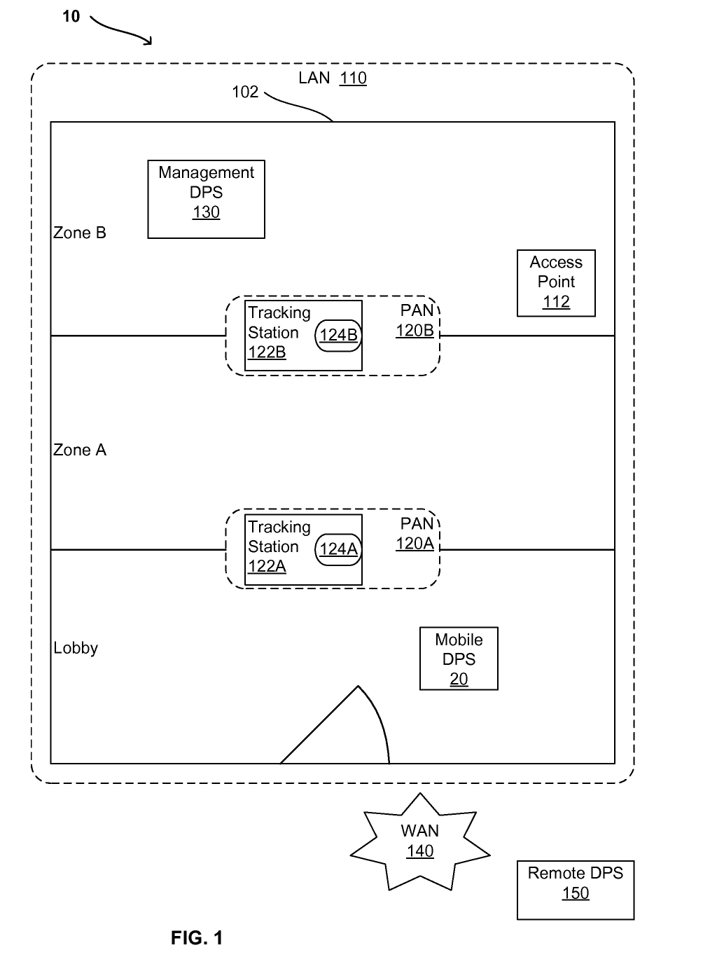

FIG. 1 is a schematic diagram of an example PAS system 10. For purposes of illustration, this disclosure describes PAS system 10 as being controlled by a hypothetical organization or enterprise called ACME. In the example embodiment, ACME uses PAS system 10 to enforce security restrictions within a building 102. Accordingly, a computer security administrator for ACME has configured building 102 with three distinct security zones: the lobby, Zone A, and Zone B. A person or user may carry a mobile data processing system (DPS) 20 into the different security zones within building 102. ACME may use a management DPS 130 in building 102 along with tracking stations 122A and 122B to orchestrate computer security within building 102. Tracking stations may also be referred to as administrative consoles or security consoles. Management DPS 130 may also be referred to as a security console. Items like the security consoles and mobile DPS 20 may be referred to collectively as PAS system 10 or as a PAS administration network 10.

An access point 112 provides local area network (LAN) coverage for building 102. The LAN 110 provided by access point 112 may use wired communication techniques and/or wireless communication techniques. In the embodiment of FIG. 1, access point 112 uses intermediate range wireless technology.

Any suitable technology or combination of technologies may be used for intermediate range communications within a LAN, including without limitation techniques which follow one or more of the various Institute of Electrical and Electronics Engineers (IEEE) 802.11 standards or protocols. For purposes of this disclosure, all of the 802.11 protocols may be referred to as a WiFi protocol.

In addition, different personal area networks (PANs) 120A and 120B cover respective choke points between each of the security zones. For instance, tracking station 122A may use a wireless communication module 124A to provide PAN 120A, and tracking station 122B may use a wireless communication module 124B to provide PAN 120B. As described in greater detail below, those wireless communication modules may use short range wireless technology to read data from and write data to mobile DPSs. The PANs may also be referred to as air gapped networks or wireless PANs (WPANs).

Any suitable technology or combination of technologies may be used for short range communications within a PAN, including, without limitation, (a) techniques which follow one or more of the various radio frequency identification (RFID) standards or protocols; and (b) techniques which follow IEEE 802.15 standards or protocols, including 802.15.1 (e.g., Bluetooth) and 802.15.4 (e.g., ZigBee).

Accordingly, tracking stations may determine the location of a mobile DPS based on RFID, Bluetooth, ZigBee, or any other suitable protocol for communicating with the mobile DPS.

In addition, tracking stations and mobile DPSs may use short range wireless technology for LAN communications, possibly in conjunction with intermediate range wireless technology and/or wired technology.

For purposes of this disclosure, intermediate range wireless technologies may have an indoor range of about 300 feet, about 200 feet, about 100 feet, or less from the wireless router or other wireless access point. By contrast, short range wireless technologies may have an indoor range about 33 feet, about 6 feet, or less. For instance, in the embodiment of FIG. 1, access point 112 may be implemented as a wireless router that supports multiple different 802.11 protocols, including at least one protocol with an indoor range of about 230 feet (e.g., 802.11n); and wireless communication modules 124A and 124B may use ultrahigh frequency (UHF) RFID readers operating at 865-868 megahertz (MHz) or 902-928 MHz, with an indoor range of about 6 feet.

In at least one embodiment, the choke points are designed to force all users (a) to pass through PAN 120A whenever they move between the lobby and zone A and (b) to pass through PAN 120B whenever they move between zone A and zone B. In addition, PAN 120A and PAN 120B are implemented with ranges that do not overlap each other, but do overlap at least part of LAN 110. Thus, in the embodiment of FIG. 1, each PAN covers a single choke point.

Management DPS 130 may communicate with the tracking stations via LAN 110. In addition or alternatively, Management DPS 20 may communicate with the tracking stations via RFID or other wireless or wired communication protocols directly. If the security settings of PAS system 10 allow, mobile DPS 20 may also use LAN 110. Management DPS 130 and/or other data processing systems within building 102 may also communicate with one or more remote data processing systems 150 via a wide area network (WAN) 140, such as the Internet.

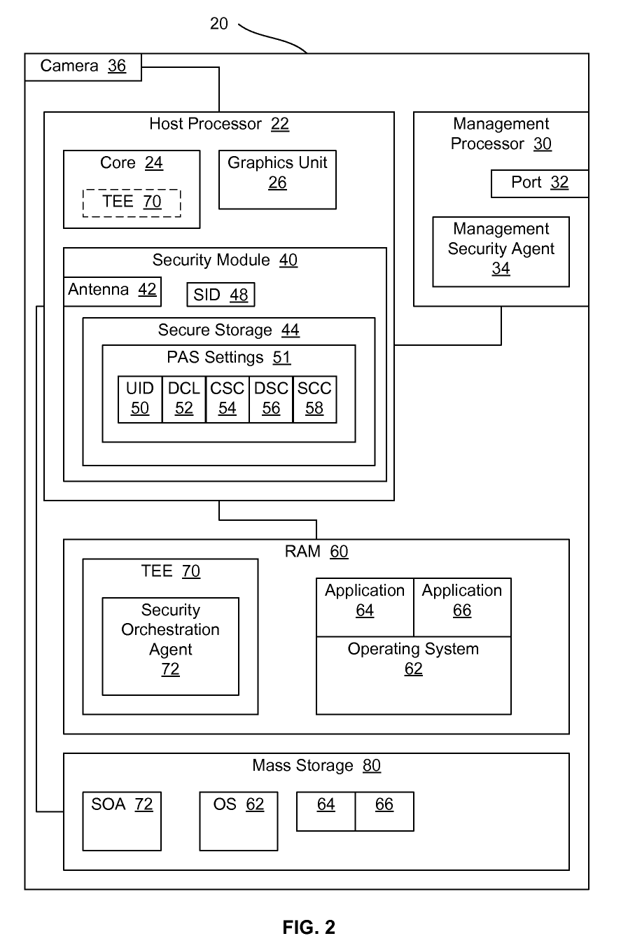

As described in greater detail below with regard to FIG. 2, mobile DPS 20 includes a secure storage component that the tracking stations can read from and write to even when mobile DPS 20 is powered off. Similarly, tracking stations 122A and 122B implement the PANs using a communications technology that allows the tracking stations to read from and write to the secure storage component of mobile DPS 20 even when mobile DPS 20 is powered off.

FIG. 2 is a block diagram depicting mobile DPS 20 in greater detail. As shown, mobile DPS 20 includes at least one host processor 22 in communication with various hardware components, such as a management processor 30, random access memory (RAM) 60, mass storage 80, and a camera 36.

Management processor 30 may include a management security agent (MSA) 34 and a network port 32. Alternatively, the management processor and the network port may reside in separate modules, and management processor may reside between the network port and the host processor. Management processor 30 may execute MSA 34 independently of any operating system or user applications in mobile DPS 20. Consequently, MSA 34 may be referred to as an out-of-band execution entity. To provide for independence and tamper resistant, isolated execution, management processor 30 may execute MSA 34 from storage that is dedicated to management processor 30 and isolated from other components of mobile DPS 20. Additionally, MSA 34 may allow other data processing systems, such as management DPS 130, to communicate with mobile DPS 20 via LAN 110 and port 32 when mobile DPS 20 is sleeping and/or powered off. For instance, management processor 30 may include features like those described for a management engine (ME) in association with the technology described and/or distributed by Intel Corporation under the name or trademark INTEL ACTIVE MANAGEMENT TECHNOLOGY (AMT). In other embodiments, management processors may use other technologies.

In the embodiment of FIG. 1, host processor 22 includes multiple execution units, including one or more general purpose cores 24, one or more graphics units 26, and a security module 40.

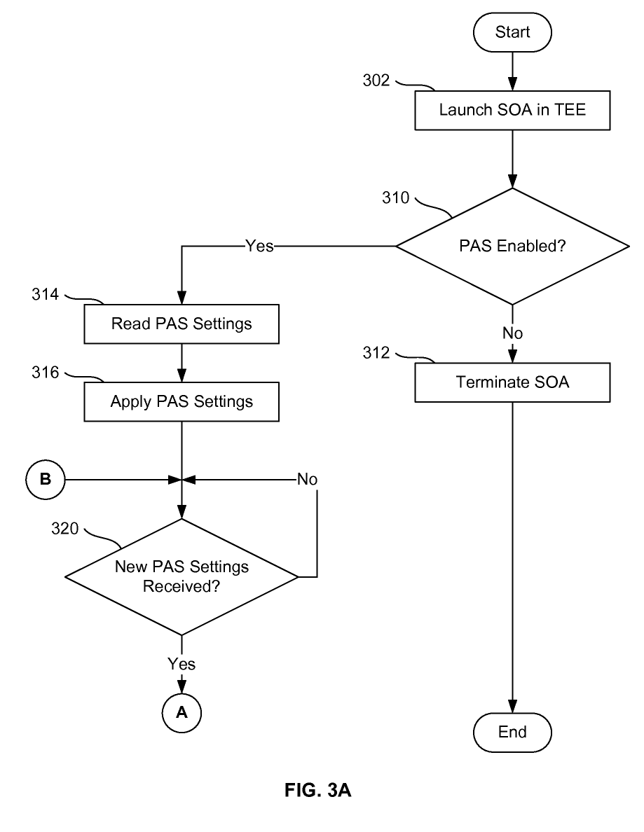

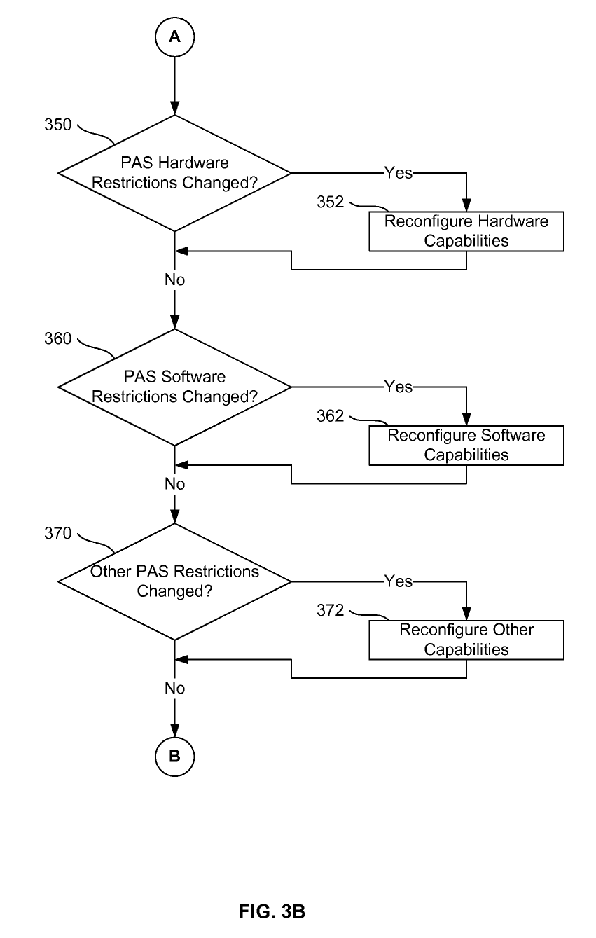

Mass storage 80 may be implemented using any suitable storage technology or combination of storage technologies, including without limitation a hard disk drive (HDD), a solid state drive (SSD), read-only memory (ROM), and/or other types of non-volatile or volatile storage technologies. Mass storage 80 includes various sets of instructions that may be loaded into RAM 60 and executed by core 24. Those sets of instruction may include an operating system 62, as well as user applications 64 and 66 that may run on top of operating system 62. Those sets of instructions also include a security orchestration agent (SOA) 72. SOA 72 may also be referred to as a location-based security agent (LBSA). As explained below, core 24 may run SOA 72 in a trusted execution environment (TEE) 70. Furthermore, TEE 70 may operate independently of any operating system or user applications. Consequently, SOA 72 may be referred to as an out-of-band execution entity. A trusted execution environment may also be referred to as secure execution environment. In other embodiments, the SOA need not run in a TEE. TEE 70 is described in greater detail below with regard to FIGS. 3A and 3B.

In the embodiment of FIG. 2, security module 40 includes an antenna 42 suitable for RFID communications. Other embodiments may use security modules with antennae suitable for other types of short range wireless communication.

In the embodiment of FIG. 2, security module 40 also includes secure storage 44. For instance, security module 40 may be implemented as an embedded secure element, and security module 40 may include features like those described under the name or trademark Wireless Credential Exchange (WCE). In addition or alternatively, security module 40 may include features like those provided by the RFID integrated circuits (ICs) described or distributed under names or trademarks like Monza, Monza X, etc.

For purposes of this disclosure, secure storage is storage that is protected from unauthorized access. In other words, secure storage is inaccessible to non-authorized entities. For instance, secure storage 44 may be protected by a password. As described in greater detail below, tracking stations 122A and 122B may communicate with secure storage 44 via antenna 42, provided that (a) mobile DPS 20 has been configured to recognize tracking stations 122A and 122B as authorized entities or (b) tracking stations 122A and 122B have been provided with the password that protects secure storage 44 from unauthorized access.

Also, a hardwired communication channel or bus (e.g., an Inter-Integrated Circuit (I²C) bus) may allow software within TEE 70 on host processor 22 such as SOA 72 to access secure storage 44. However, access to secure storage 44 via the hardwired channel may be protected by an access control mechanism, such as a personal identification number (PIN), a password, or another factor that is required in order to unlock access. This can include locking based on the operating phase of mobile DPS 20, wherein the storage is accessible immediately after a platform restart, but then locked prior to running third party code such as operating system or user software. In addition or alternatively, secure storage 44 may be unlockable during runtime via presentation of an authorization value, such as a password. For instance, secure storage 44 may be implemented as an Opal drive, in accordance with the Opal Storage Specification from the Trusted Computing Group, or secure storage 44 may be protected like a smart card. Accordingly, the hardwired channel to secure storage 44 may be referred to as a secure channel.

In addition, as indicated below, tracking stations may use a short range wireless protocol such as RFID to read from and/or write to secure storage 44, independently of the hardwired bus. Communications between tracking stations and security module 40 may also be independent of any operating system or user applications on mobile DPS 20. As indicated above, tracking stations may even be able read from and write to secure storage when mobile DPS 20 is sleeping or powered off Consequently, communications between tracking stations and security module 40 may be referred to as out of band.

Since secure storage 44 is used to store security settings and secure storage 44 is protected against unauthorized access via both the wired and wireless ports, secure storage 44 may be referred to as a tamper-proof policy store. In one embodiment, secure storage 44 is implemented using technology described by Intel Corp. under the name or trademark Wireless Credential Exchange (WCE) or Processor Secured Storage (PSS). WCE involves an RFID device with some local storage and computation. With WCE, the device may store a small amount of keying material that responds to an incident radio frequency (RF) wave. This storage can be used to hold policy information or other keying material. Other techniques may be used to protect the secure storage in other embodiments.

With regard to FIG. 1, management DPS 130 and/or remote DPS 150 may include components like those in mobile DPS 20 and/or any other suitable components.

Referring again to FIG. 2, secure storage 44 includes PAS settings 51 for mobile DPS 20. As illustrated, PAS settings 51 may include (a) a user identifier (UID) 50 to uniquely identify the current user of mobile DPS 20, (b) a device capabilities list (DCL) 52 to list functional units within mobile DPS 20, (c) a current security configuration (CSC) 54 for mobile DPS 20, and (d) a default security configuration (DSC) 56 for mobile DPS 20. DCL 52 may identify different modules, components or functional units present on the platform. For instance, DCL 52 may identify applications 64 and 66 and camera 36 as present on mobile DPS 20. DCL 52 may also indicate which components are currently active or enabled, and which are inactive or disabled. Thus, DCL 52 may serve as a “white list” and/or a “black list.”

Security module 40 may also include a system identifier (SID) 48 to uniquely identify mobile DPS 20. In addition, SID 48 may be stored in encrypted form, so that only authorized entities (e.g., tracking stations 122A and 122B) can determine the plaintext form of SID 48.

In the embodiment of FIG. 2, security module 40 operates in at least some respects like an RFID tag. Accordingly, security module 40 may be implemented more or less as an RFID module or chip with a unique identifier, and that unique identifier may be used as SID 48. Alternatively, any other suitable identifier may be used as the SID.

The mobile DPSs to operate with LAN 110 may include systems owned by ACME (e.g., work laptops), as well as systems owned by individuals (e.g., smart phones owned by ACME employees. A system that is owned by an individual may also be referred to as a “bring your own device” or “BYOD.” In one embodiment, BYODs must be provisioned and registered by an ACME administrator before those BYODs can use LAN 110.

An ACME security administrator may load the initial PAS settings 51 into secure storage 44 during a preliminary process for configuring mobile DPS 20 to enable mobile DPS 20 to be used within building 102. Also, since secure storage 44 can only be accessed by authorized entities, the administrator may load mobile DPS 20 with data to identify all tracking stations which should be allowed to read from and/or write to secure storage 44. The identifiers for those tracking stations may be referred to as security console credentials (SCC) 58, and SCC 58 may be stored in secure storage 44, for example. Consequently, there is a binding between the authorized tracking stations and the mobile DPSs that have been registered to operate within LAN 110.

The administrator may also install SOA 72 onto mobile DPS 20. In addition or alternatively, some or all of the required software and settings could be installed during manufacturing or at some other point in time.

To enable the administrator to read from and write to secure storage 44, especially in the case of a BYOD, the owner of mobile DPS 20 may provide the administrator with the password for secure storage 44. Alternatively, especially in the case of a device owned by ACME, the administrator may already know the password, and the administrator, by design, may have higher privileges allowing the administrator to override user settings.

The administrator may also register mobile DPS 20 with the security consoles of PAS system 10. As part of that registration process, the administrator may share SID 48 and the password for secure storage 44 with tracking stations 122A and 122B. As indicated below, tracking stations 122A and 122B may subsequently use the registered SID to authenticate mobile DPS 20, and tracking stations 122A and 122B may use the password to read from and write to secure storage 44. The administrator may also share a key for decrypting SID 48 with management DPS 130 and tracking stations 122A and 122B. For instance, the administrator may provide the security consoles with a private key, and the administrator may provide mobile DPS 20 with a corresponding public key, to be used to encrypt SID 48.

FIGS. 3A and 3B present a flowchart of an example process for using PAS, from the perspective of mobile DPS 20. That process may start every time mobile DPS 20 gets activated by a user (for instance, when resuming from standby, when waking from sleep, when being unlocked, when starting after being powered down or reset, etc.) or every time mobile DPS 20 enters or exits a protected location. When mobile DPS 20 is activated, or when mobile DPS 20 enters or exits a protected location, mobile DPS 20 may launch SOA 72 in TEE 70, as shown at block 302.

Additionally, mobile DPS 20 may verify that SOA 72 has not been tampered with. In one embodiment, a cyclic redundancy code (CRC) is used to perform this verification. In the embodiment of FIG. 2, mobile DPS 20 includes features known by the name or trademark Intel Trusted Execution Technology (TXT), and TEE 70 is part of a measured launch environment (MLE). In addition or alternatively, mobile DPS 20 may use technology known by the name or trademark Intel Software Guard eXtensions (SGX) to launch SOA 72 in a secure enclave, with that secure enclave illustrated in FIG. 2 as TEE 70. Accordingly, mobile DPS 20 may measure SOA 72, may validate that measurement, and after successful validation, may launch SOA 72 within TEE 70 on core 24. More information about Intel® TXT is available at www.intel.com/content/dam/www/public/us/en/documents/white-papers/trusted-execution-technology-security-paper.pdf. More information about Intel® SGX is available on the web at software.intel.com/en-us/attestation-sealing-withsoftware-guard-extensions.

In other embodiments, other techniques may be used to provide a TEE. For instance, the SOA may be protected by one or more security agents in the chipset of the mobile DPS. This security agent (or these security agents) may periodically check the integrity of the SOA, for instance by storing a hash of the SOA in protected storage of the security agent and using the isolated execution of the security agent to determine if the SOA has been modified by an untoward entity. In other words, if the SOA has functionA and functionB, the security agent may compute hash (functionA∥functionB)=Digest_golden on startup. At subsequent times, the security agent may recompute the digest, based on the current contents of the SOA, such as digest=D(1) at time t=1, D(2) at time t=2, etc., where D(t)=hash (functionA∥functionB) at time=t. If any D(t) does not equal to D(0), the security agent may conclude that corruption has occurred. The security agent may thus serve as a sentinel, protecting the SOA by detecting if the SOA has been corrupted, possibly stopping the SOA before any further harm can be done, if corruption is detected.

Alternately, a monolithic SOA may be factored or divided, and the security critical portions of the SOA may be moved into a security agent. For purposes of illustration, a security critical portion of code from the SOA may be referred to as “FunctionA,” and the corresponding code within the security agent may be referred to as “FunctionB.” FunctionB may be an isolated, protected implementation of FunctionA. Consequently, when the SOA calls FunctionA, the SOA may actually invoke the class of service of functionB via an IPC sent to the security agent. In one embodiment, the SOA is built so that, on startup, the security critical portions are migrated to the security processor. Thus, certain tasks or functions may be offloaded onto the security agent. This security agent may have isolated storage and execution facilities, thus providing a segregated offload or portions of the SOA functionality. The mobile DPS may use a dynamic application loader (DAL) to load such security agents, and the security agents may communicate with components like core 24 and/or security module 40 using interprocess or interprocessor communication (IPC) over a Host-Embedded Communication Interface (HECI) bus. In addition or alternatively, the TEE may be implemented using technology described by ARM Ltd. under the name or trademark TrustZone.

In addition or alternatively, the TEE may operate as a tamper resistant, secure, isolated execution environment, independent of the host processor. For example, the TEE may be implemented using a dedicated Converged Security Manageability Engine (CSME) on a management processor. The CSME may operate like MSA 34, for instance.

Other embodiments may use any suitable combination of the above techniques, and/or other techniques, to protect the TEE.

In one embodiment, SOA 72 is protected and verified as safe at the platform level. In other words, the verification and protection is provided by components which execute below the level of the operating system and below the level of user applications, so that faulty or malicious code in the operating system or in a user application is unable to corrupt SOA 72. For instance, SOA 72 may be digitally signed by an original equipment manufacturer (OEM) or original equipment manufacturer (ODM) for mobile DPS 20, and a pre-boot loader on mobile DPS 20 may use that signature to verify the authenticity and purity of SOA 72 during platform boot, possibly as part of the root-of-trust.

After platform boot, TEE 70 may prevent access or modifications of the SOA 72 by unauthorized entities (e.g., applications, operating systems, libraries, drivers, virtual machines, virtual machine monitors, processes, threads, etc.) running in mobile DPS 20. In one embodiment, mobile DPS 20 does not allow any software to execute within a TEE unless that software has first been verified as safe. For example, mobile DPS 20 may use techniques such as those described by Intel Corp, under the name or trademark Launch Control Policy (LCP) to control admission of code into the TEE. Mobile DPS 20 may also prevent any software executing outside of the TEE to access any of the storage areas protected by the TEE. In various embodiments, TEEs may be implemented as secure enclaves, virtualized partitions, virtual machines, sandboxes, etc.

In addition or alternatively, the SOA may be signed and verified. For instance, the mobile DPS may use techniques such as those referred to be Microsoft Corp. as Code Integrity (CI) to cryptographically verify the SOA before allowing the SOA to execute.

As shown at block 310, after mobile DPS 20 launches SOA 72, SOA 72 may automatically determine whether PAS is enabled for mobile DPS 20. If PAS is not enabled, SOA 72 may terminate itself, as shown at block 312, and mobile DPS 20 may then operate without the features of SOA 72 described below (e.g., without dynamically applying policy changes to dynamically configure or constrain hardware or software utilization).

If PAS is enabled, SOA 72 may then read PAS settings 51 for mobile DPS 20, as shown at block 314. For instance, SOA 72 may use a hardwired bus of mobile DPS 20 to read PAS settings 51 from secure storage 44. And to obtain access to the data in secure storage 44, SOA 72 may use the password or other control factor that is protecting secure storage 44. For example, if the secure storage is implemented as an Opal drive, the SOA may provide an Opal style authorization value. Alternatively, the SOA may first use a token value to unseal or release a key, and the SOA may then use that key to decrypt storage. Alternatively, challenge/response verification may be mandated. The mobile DPS may use any suitable technology to seal keys and/or other data in storage, including without limitation a Trusted Platform Module (TPM) and Intel® SGX.

In another embodiment, the security module and the host processor both reside on a single integrated circuit (IC) or “system on a chip” (SOC), and they communicate with each other via a hardwired bus that is internal to SOC. In such an embodiment, the SOA may be able to read the secure storage via the hardwired bus without a password.

After reading PAS settings 51 from secure storage 44, SOA 72 may then apply PAS settings 51 for mobile DPS 20, as shown at block 316. When applying PAS settings 51, SOA 72 may configure mobile DPS 20 according to CSC 54, as described in greater detail below with regard to blocks 350, 352, 360, 362, 370, and 372 of FIG. 3B. Mobile DPS 20 may then operate in accordance with the constraints specified by CSC 54. Accordingly, items like CSC 54 may be referred to as security-critical policy objects.

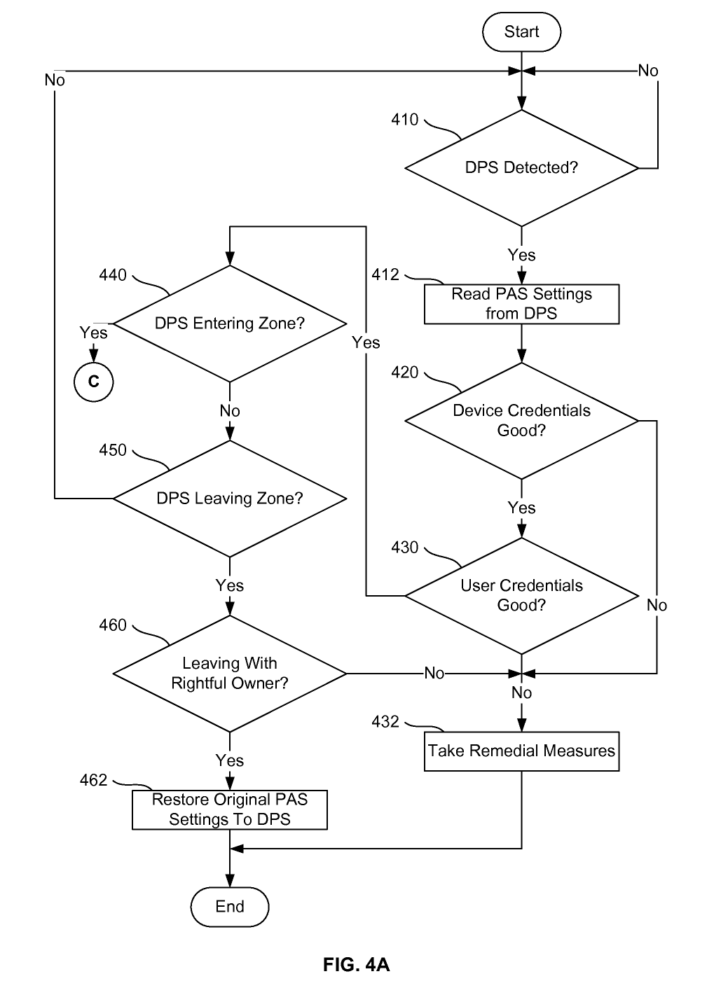

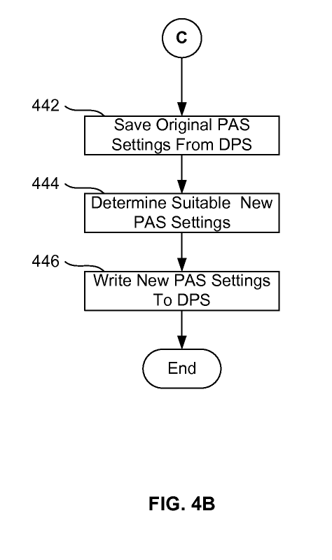

SOA 72 may then wait for mobile DPS 20 to receive new PAS settings (e.g., a new CSC), as shown at block 320. For instance, as described in greater detail below with regard to FIG. 4, mobile DPS 20 may receive new PAS setting from a tracking station in response to the tracking station detecting that mobile DPS 20 is entering or leaving a security zone associated with the tracking station.

However, before mobile DPS 20 allows the tracking station to read from and/or write to secure storage 44, mobile DPS 20 may require the tracking station to provide credentials (e.g., a unique identifier for the tracking station). Mobile DPS 20 may then verify that the tracking station is an authorized entity, based on the received credentials, and based on the identifiers for the authorized tracking stations that were provided to mobile DPS 20 during registration of mobile DPS 20, as indicated above. In addition or alternatively, as indicated above, the tracking stations may need to provide the password for secure storage 44 in order to read from or write to secure storage 44.

Once mobile DPS 20 receives new PAS settings, the process of FIG. 3A may pass through page connector A to FIG. 3B. When mobile DPS 20 receives new PAS settings, the old settings may be referred to as the original PAS settings.

As shown at block 350 of FIG. 3B, in response to mobile DPS 20 receiving new PAS settings, SOA 72 may automatically determine whether those settings require any hardware restrictions for mobile DPS 20 to be changed. If the new PAS settings involve different hardware restrictions than the original settings, SOA 72 may reconfigure the hardware capabilities of mobile DPS 20, as shown at block 352. For instance, if the original CSC did not impose any hardware restrictions and the new CSC prohibits the use of any cameras, SOA 72 may respond by automatically disabling camera 36. In other circumstances, the new CSC may cause SOA 72 to enable one or more disabled hardware components. In addition or alternatively to disabling or enabling camera 36, in response to receiving the new CSC, SOA 72 may disable or enable other types of hardware, including without limitation input/output (I/O) hubs, Universal Serial Bus (USB) ports, audio ports, keyboard ports, memory modules, non-volatile storage devices, co-processors or accelerators, network interface cards (NICs), power buttons, etc.

In one embodiment, the operating system grants hardware management privileges to the SOA. In another embodiment, the SOA is embedded in a type 1 hypervisor (i.e., a hypervisor with no underlying operating system), and the SOA has direct access to hardware resources. In other embodiment, other techniques may be used to give the SOA hardware management privileges.

SOA 72 may use any suitable techniques to enable and disable hardware components. For instance, SOA 72 may occlude or block access to device command/status registers in the SOC address space. In addition or alternatively, SOA 72 may use a disable device select (devsel#) line for a PCI device. In addition or alternatively, SOA 72 may refrain from reporting device existence in one or more industry standard data structures for reporting hardware attributes (e.g., an Advanced Configuration and Power Interface (ACPI) table) and/or in one or more proprietary data structures for reporting hardware attributes. In addition or alternatively, if operating as part of a hypervisor, the SOA may disable a device by refraining from passing through I/O transactions from a virtual device to a physical device, or by removing the “device model” instance, so that the guest OS cannot discern or discover that device. In addition or alternatively, the SOA can instruct a virtual device that is exposed to the guest OS to be non-functional to command requests when a disable action has been activated.

In addition, as shown at block 360, SOA 72 automatically determines whether the new PAS settings 51 require any software restrictions for mobile DPS 20 to be changed. If the new PAS settings 51 involve different software restrictions than the original settings, SOA 72 may reconfigure the software capabilities of mobile DPS 20, as shown at block 362. For instance, if the original CSC did not impose any software restrictions and the new CSC prohibits the use of any web browser applications, SOA 72 may respond by automatically disabling all web browser applications in mobile DPS 20. In other circumstances, the new CSC may cause SOA 72 to enable one or more disabled software components.

SOA 72 may use any suitable techniques to disable or enable software components. For instance, SOA 72 may disable a software component by modifying, replacing, or “hijacking” the interface to that component. For instance, SOA 72 may use an access control logic (ACL) layer to mediate access to services. For example, if a software component provides a service referred to as ServiceX, SOA 72 may interpose a ServiceXAclLayer that intercepts all calls to ServiceX, and ServiceXAclLayer can include a policy object to allow or prevent access to ServiceX under different predetermined conditions. SOA 72 may then use ServiceXAclLayer, with its policy object, to decide if a request from a caller to ServiceX should get passed via ServiceXAclLayer, or instead if the ServiceXAclLayer should return a ‘not available’ error. In addition or alternatively, SOA 72 may disable software components by changing application or system settings in a control panel of OS 62. In addition or alternatively, SOA 72 may use environment variables to disable software components. Such environment variables may be part of a firmware interface (e.g., a Unified Extensible Firmware Interface (UEFI)), and they may be shared with OS 62 from system management mode (SMM).

As shown at block 370, SOA 72 may then automatically determine whether the new PAS settings 51 require any other security restrictions for mobile DPS 20 to be changed. For instance, PAS settings 51 may grant access to data (e.g., a particular file or folder on LAN 110) or to network resources (e.g., a network printer) that mobile DPS 20 typically does not have access to, or PAS settings 51 may deny access that mobile DPS 20 normally has. If the new PAS settings 51 involve different restrictions than the original settings, SOA 72 may reconfigure the capabilities of mobile DPS 20 according to the new settings, as shown at block 372. For instance, PAS system 10 may be configured to prevent all mobile DPS from accessing the files in a particular folder on the network, except for a particular mobile DPS, if that mobile DPS is being operated by a particular user, in a particular security zone.

SOA 72 may use DCL 52 to determine which components are present, which are active or enabled, and which are inactive or disabled. And SOA 72 may update DCL 52 to reflect the changes made by SOA 72.

SOA 72 may enable components using the same kinds of techniques described above with regard to disabling components.

Once SOA 72 has reconfigured the capabilities of mobile DPS 20, the process of FIG. 3B may then pass through page connector B back to block 320 of FIG. 3A, with SOA continuing to monitor whether mobile DPS 20 receives new PAS settings, and proceeding accordingly, as described above.

FIGS. 4A and 4B present a flowchart of an example process for using PAS, from the perspective of a tracking station or tracking system. As indicated above, a tracking station may include a wireless communication module. The process of FIG. 4 may start with a tracking station (e.g., tracking station 122A) waiting for a data processing system (e.g., mobile DPS 20) to enter the range of the wireless communication module (e.g., wireless communication module 124A). Once mobile DPS 20 enters the range of wireless communication module 124A, tracking station 122A responds by automatically reading PAS settings 51 from mobile DPS 20, as shown at block 412. In particular, mobile DPS 20 may (a) read SID 48 from security module, (b) decrypt SID 48 if necessary, (c) look up the password for secure storage 44, based on SID 48, and then (d) use that password to read PAS settings 51 from secure storage 44. Thus, tracking station 122A may use SID 48 as a token or index into a database, to look up the password for secure storage 44 in mobile DPS 20.

In addition or alternatively, before mobile DPS 20 allows tracking station 122A to access secure storage 44, mobile DPS 20 may require tracking station 122A to provide other types of credentials; and mobile DPS 20 may determine whether tracking station 122A is an authorized entity, based on the credentials provided by tracking station 122A, in conjunction with the tracking station credentials or identifiers received during configuration.

As indicated above, PAS settings 51 include user credentials such as UID 50. After reading PAS settings 51, tracking station 122A may then validate the user and device credentials. In particular, as shown at block 420, tracking station 122A may determine whether security credentials for mobile DPS 20 are good. For instance, tracking station 122A may verify that mobile DPS 20 is registered as an authorized device, based on SID 48. If the device credentials are good, tracking station 122A may then determine whether security credentials for the current user of mobile DPS 20 are good, as shown at block 430. For instance, SOA 72 may verify that the current user of mobile DPS 20 is registered as an authorized user, based on UID 50.

If the device or user credentials are not good, tracking station 122A may take remedial or protective measures, as shown at block 432. For instance, tracking station 122A may write a new CSC 54 to secure storage 44, and that new configuration may cause mobile DPS 20 to disable some or all hardware and/or software components of mobile DPS 20. For instance, if tracking station 122A is protecting very sensitive resources, and mobile DPS 20 does not have good credentials, the new settings may completely shut down and disable or “brick” mobile DPS 20. To re-enable mobile DPS 20, it may then be necessary to take mobile DPS 20 to a different tracking station (e.g., a tracking station operated by a security administrator for ACME in a secure room). Other potential remedial actions include, without limitation, encrypting some or all of the data in mobile DPS 20 or erasing some or all of the data in mobile DPS 20, and then shutting down and/or bricking mobile DPS. After the remedial actions are taken, the process of FIG. 4B may then end.

However, referring again to block 430, if the device and user credentials are good, tracking station 122A may then determine whether mobile DPS 20 is entering zone A, as shown at block 440. If so, the process may pass through page connector C to FIG. 4B. Tracking station 122A may then save the original PAS settings for subsequent use, as shown at block 442. Tracking station 122A may also automatically determine suitable new PAS settings for the operation of mobile DPS 20 within zone A, as shown at block 444 and described in greater detail below. Tracking station 122A may then utilize wireless communication module 124A to write the new PAS settings to secure storage 44, as shown at block 446. For instance, tracking station 122A may use the password for secure storage 44 to write a new CSC 54 into secure storage 44.

In response to receiving new PAS settings, mobile DPS 20 may automatically reconfigure its security configuration in accordance with those settings, as described above with regard to FIGS. 3A and 3B.

However, referring again to FIG. 4A, if mobile DPS 20 is not entering zone A, tracking station 122A may determine whether mobile DPS is leaving zone A, as shown at block 450. If mobile DPS 20 is leaving zone A, tracking station 122A may then determine whether mobile DPS 20 is leaving with the rightful owner or authorized user, as shown at block 460. If mobile DPS 20 is being taken by an unauthorized person, tracking station 122A may automatically take remedial measures to deter unauthorized use of mobile DPS 20 and/or to notify the rightful owner, as indicated at block 432 and described in greater detail above and below. However, of mobile DPS 20 is leaving with the rightful owner, tracking station 122A may then utilize wireless communication module 124A to restore the original PAS settings to secure storage 44, as shown at block 462. In response to having the original PAS settings restored, mobile DPS 20 may automatically reconfigure its security configuration in accordance with those settings, as described above with regard to FIGS. 3A and 3B. The process of FIG. 4A may then end.

As indicated above, in one embodiment, a tracking station cannot read from or write to secure storage in a mobile DPS unless the tracking station has credentials to talk to the secured storage. Any suitable technique may be used to validate such credentials. For instance, the tracking station and the secure storage within the mobile DPS may perform a key exchange protocol before or in conjunction with the tracking station writing to the secure storage.

As indicated above, when tracking station 122A determines that mobile DPS 20 is entering zone A, tracking station 122A may automatically determine suitable new PAS settings for mobile DPS 20 to use while operating within zone A. Tracking station 122A may consider many different factors when determining which PAS settings are suitable for mobile DPS 20, including without limitation device identity, user identity, date, time of day, specific predetermined restrictions for zone A, etc. In addition, some or all of the factors considered by tracking station 122A may come from management DPS 130. In addition or alternatively, management DPS 130 may determine suitable new PAS settings, and management DPS 130 may then send those settings to tracking station 122A, for transfer to mobile DPS 20. As has been described, tracking station 122A may write or flash security tokens such as CSC 54 in real time onto mobile DPS 20. As described above with regard to FIGS. 3A and 3B, the new security tokens may trigger reconfiguration of the security settings for mobile DPS 20.

In addition, when mobile DPS 20 enters and leaves zone B, tracking station 122B may perform the same kinds of operations as those described above as being performed by tracking station 122A with regard to FIG. 4. For instance, tracking station 122B may determine whether mobile DPS 20 is entering or leaving zone B, etc.

Any suitable techniques may be used to determine whether mobile DPS 20 is entering or leaving a zone. For instance, management DPS 130 may track the location of mobile DPS 20, based on data from tracking stations 122A and 122B. In addition or alternatively, when mobile DPS 20 is in motion, tracking stations 122A and 122B may communicate with each other, like a cell-phone call transfer between towers.

In addition or alternatively, a tracking station may load a dynamic security configuration into a mobile DPS, and the tracking station may then exchange challenge/response tokens with the mobile DPS in a heart-beat fashion, with any suitable periodicity, while the mobile DPS is within range of the tracking station. Once the mobile DPS leaves the range of the tracking station, the SOA on the mobile DPS may automatically erase or disregard the dynamic security configuration provisioned by the tracking station and revert to an original or default security configuration in response to detecting the loss of the heart-beat.

In one embodiment, some or all of the choke points also have badge readers, and each individual is required to scan his or her badge before passing through the choke point. The tracking stations may then obtain the user credentials from the badge readers, and the tracking stations and/or management DPS may use those credentials for additional security functions. For instance, if the user credentials from the badge do not match the UID 50 from mobile DPS 20, the security console may send a message to the registered user or owner for mobile DPS 20 to advise the registered owner that mobile DPS 20 is being taken by the person identified by the badge. The security console may also provide other details, such as the locations that mobile DPS was entering and/or leaving, and the time. In addition or alternatively, the security console may take remedial measure, such as those discussed above with regard to block 432 of FIG. 4A.

In addition or alternatively, choke points may have surveillance cameras, biometric scanners, fingerprint readers, and/or other technology to identify individuals passing through the choke points, and the choke points may use those items instead of or in addition to the card readers to determine whether an individual passing through a choke point with a device is the registered owner or authorized user of that device.

By using the technology described herein, security administrators for ACME may have great flexibility with regard to the security restrictions to be imposed upon data processing systems operating within building 102. For instance, the tracking stations may be configured to disable certain applications or certain types of applications for all data processing systems being used in zone A, but with exceptions that allow certain specified users on certain specified machines to utilize those applications within a specified time period on a specified date. Similarly, the tracking stations may be configured to only allow certain user on certain machines within zone B to access to certain resources, such as a specified network file folder.

Furthermore, since the tracking stations can read from and write to secure storage 44 even when mobile DPS 20 is sleeping or powered off, a user cannot overcome the security restrictions by turning off mobile DPS 20 before passing through PAN 120A or PAN 120B. Also, since the tracking stations do not use LAN 110 to access secure storage 44, the tracking stations and mobile DPS 20 may enforce the predetermined security restrictions despite any breach in the security of LAN 110. Accordingly, security policy orchestration may be referred to as network independent or LAN independent. Likewise, security policy orchestration may also be independent of MSA 34 and management processor 30.

In addition, since SOA 72 operates within TEE 70, it may be difficult or impossible for malware on mobile DPS 20 to overcome the security restrictions imposed by the tracking stations.

As has been described, enterprise security administrators may configure a PAS system with security settings to control access to computing resources based on multiple contextual factors, possibly including, without limitation, the precise location of individual mobile DPSs within the building, the identity of the current users of the mobile DPSs, the date, the time, etc. Each mobile DPS may retain its PAS settings in a tamper resistant manner, in secure storage. Even if a mobile DPS were to get corrupted with malware, an SOA in the mobile DPS would be protected from the malware, since the SOA runs in a TEE. In addition or alternatively, the SOA may be signed and verified to vouch for its integrity. Thus, the secure storage and the TEE enable the mobile DPS to reliably enforce the security restrictions prescribed by the security administrators, despite malware affecting the operating system of the mobile DPS and despite a hostile IP network in the enterprise.

In addition, tracking stations may securely communicate security settings to a mobile DPS via a PAN, without using an enterprise LAN, to reduce or eliminate the risks associated with LAN vulnerability or failure.

Since the PAS system includes known tracking stations at known locations, the PAS system provides for precise identification and geo-location of mobile DPS. And since each tracking station that provides identification and geo-location information may be closely guarded, and since each tracking station communicates with mobile DPSs via an out-of-band channel, a tracking station may be considered a tamper resistant source. In one embodiment, the tracking stations determine location without using spoofable attributes like network and IP address.

In accordance with the present teachings, administrators may easily configure a PAS system to enforce a wide variety of security policies. For example, security administrators may restrict or allow access to computing resources depending on the physical location of the device being used by an authorized person. For example, information technology (IT) administrators may restrict mobile DPSs being by part time employees to allow access to classified documents only within a restricted access lab, and only while the DPSs have no operable cameras.

Similarly, if ACME wants to prohibit a certain mobile DPS from being used outside of the ACME building, the security consoles may be programmed to automatically load a failsafe policy into that mobile DPS whenever the security console detects that that the mobile DPS is being removed from the building. The failsafe policy may cause the SOA in that mobile DPS to automatically disable or brick the mobile DPS as soon as anyone tries to operate the mobile DPS outside of the ACME building. In addition or alternatively, the failsafe policy may cause the SOA to perform full encryption on a predetermined portion of the data or all of the data in the mobile DPS. In addition or alternatively, if the mobile DPS is running when it leaves, the failsafe policy may force mobile DPS to shut itself odd and disable powering on as long as mobile DPS is outside of an authorized zone.

As another example, if doctors and nurses in a hospital are supposed to share a mobile DPS, the PAS system may be configured to load different PAS settings into the mobile DPS, depending on whether the current user is a doctor or a nurse, depending on which floor the mobile DPS is being used on, etc. The PAS settings may result in the doctors having rights to write prescriptions within certain locations or zones, while those rights are not granted to nurses. And the PAS settings may prevent the doctors from writing prescriptions if the mobile DPS is not within an authorized location or zone.

In light of the principles and example embodiments described and illustrated herein, it will be recognized that the illustrated embodiments can be modified in arrangement and detail without departing from such principles. Also, the foregoing discussion has focused on particular embodiments, but other configurations are contemplated. Also, even though expressions such as “an embodiment,” “one embodiment,” “another embodiment,” or the like are used herein, these phrases are meant to generally reference embodiment possibilities, and are not intended to limit the invention to particular embodiment configurations. As used herein, these phrases may reference the same embodiment or different embodiments, and those embodiments are combinable into other embodiments.

Any suitable operating environment and programming language (or combination of operating environments and programming languages) may be used to implement components described herein. As indicated above, the present teachings may be used to advantage in many different kinds of data processing systems. Example data processing systems include, without limitation, distributed computing systems, supercomputers, high-performance computing systems, computing clusters, mainframe computers, mini-computers, client-server systems, personal computers (PCs), workstations, servers, portable computers, laptop computers, tablet computers, personal digital assistants (PDAs), telephones, handheld devices, entertainment devices such as audio devices, video devices, audio/video devices (e.g., televisions and set top boxes), vehicular processing systems, and other devices for processing or transmitting information. Accordingly, unless explicitly specified otherwise or required by the context, references to any particular type of data processing system (e.g., a mobile device) should be understood as encompassing other types of data processing systems, as well. Also, unless expressly specified otherwise, components that are described as being coupled to each other, in communication with each other, responsive to each other, or the like need not be in continuous communication with each other and need not be directly coupled to each other. Likewise, when one component is described as receiving data from or sending data to another component, that data may be sent or received through one or more intermediate components, unless expressly specified otherwise. In addition, some components of the data processing system may be implemented as adapter cards with interfaces (e.g., a connector) for communicating with a bus. Alternatively, devices or components may be implemented as embedded controllers, using components such as programmable or non-programmable logic devices or arrays, application-specific integrated circuits (ASICs), embedded computers, smart cards, and the like. For purposes of this disclosure, the term “bus” includes pathways that may be shared by more than two devices, as well as point-to-point pathways.

This disclosure may refer to instructions, functions, procedures, data structures, application programs, microcode, configuration settings, and other kinds of data. As described above, when the data is accessed by a machine or device, the machine or device may respond by performing tasks, defining abstract data types or low-level hardware contexts, and/or performing other operations. For instance, data storage, RAM, and/or flash memory may include various sets of instructions which, when executed, perform various operations. Such sets of instructions may be referred to in general as software. In addition, the term “program” may be used in general to cover a broad range of software constructs, including applications, routines, modules, drivers, subprograms, processes, and other types of software components. Also, applications and/or other data that are described above as residing on a particular device in one example embodiment may, in other embodiments, reside on one or more other devices. And computing operations that are described above as being performed on one particular device in one example embodiment may, in other embodiments, be executed by one or more other devices.

It should also be understood that the hardware and software components depicted herein represent functional elements that are reasonably self-contained so that each can be designed, constructed, or updated substantially independently of the others. In alternative embodiments, many of the components may be implemented as hardware, software, or combinations of hardware and software for providing the functionality described and illustrated herein. For example, alternative embodiments include machine accessible media encoding instructions or control logic for performing the operations of the invention. Such embodiments may also be referred to as program products. Such machine accessible media may include, without limitation, tangible storage media such as magnetic disks, optical disks, RAM, ROM, etc., as well as processors, controllers, and other components that include RAM, ROM, and/or other storage facilities. For purposes of this disclosure, the term “ROM” may be used in general to refer to non-volatile memory devices such as erasable programmable ROM (EPROM), electrically erasable programmable ROM (EEPROM), flash ROM, flash memory, etc. In some embodiments, some or all of the control logic for implementing the described operations may be implemented in hardware logic (e.g., as part of an integrated circuit chip, a programmable gate array (PGA), an ASIC, etc.). In at least one embodiment, the instructions for all components may be stored in one non-transitory machine accessible medium. In at least one other embodiment, two or more non-transitory machine accessible media may be used for storing the instructions for the components. For instance, instructions for one component may be stored in one medium, and instructions another component may be stored in another medium. Alternatively, a portion of the instructions for one component may be stored in one medium, and the rest of the instructions for that component (as well instructions for other components), may be stored in one or more other media. Instructions may also be used in a distributed environment, and may be stored locally and/or remotely for access by single or multi-processor machines.

Also, although one or more example processes have been described with regard to particular operations performed in a particular sequence, numerous modifications could be applied to those processes to derive numerous alternative embodiments of the present invention. For example, alternative embodiments may include processes that use fewer than all of the disclosed operations, process that use additional operations, and processes in which the individual operations disclosed herein are combined, subdivided, rearranged, or otherwise altered.

In view of the wide variety of useful permutations that may be readily derived from the example embodiments described herein, this detailed description is intended to be illustrative only, and should not be taken as limiting the scope of coverage.

The following examples pertain to further embodiments.

Example A1 is a tracking station to support premises-aware security. The tracking station comprises at least one processor, a short range wireless module in communication with the processor, and instructions which, when executed by the processor, enable the tracking station to perform various operations. Those operations comprise (a) detecting a data processing system (DPS) within communication range of the short range wireless module; (b) in response to detecting the DPS, using the short range wireless module to obtain identification data for the DPS from a security module of the DPS; (c) using the identification data for the DPS to obtain credentials to access secure storage in the security module of the DPS; and (d) after obtaining the identification data from the security module, automatically generating security configuration data for the DPS, based on multiple factors pertaining to the DPS. The multiple factors comprise identity of the DPS, a location of the DPS, and at least one factor from the group consisting of capabilities of the DPS, identity of a user of the DPS, and a time factor. The operations also comprise using the short range wireless module and the credentials to write the security configuration data to the secure storage in the security module of the DPS. The security configuration data calls for the DPS to automatically perform at least one operation from the group consisting of disabling at least one component of the DPS and enabling at least one component of the DPS.

Example A2 includes the features of Example A1, and the operations further comprise using the credentials to read a device capabilities list for the DPS from the secure storage before automatically generating security configuration data for the DPS.

Example A3 includes the features of Example A1, and the operations further comprise (a) when a person is leaving a secure zone with the DPS, automatically determining who is leaving with the DPS, based on information from a device other than the DPS; (b) automatically determining whether the person leaving with the DPS is an authorized user of the DPS; and (c) in response to a determination that the person leaving with the DPS is not an authorized user of the DPS, automatically taking remedial measures to deter unauthorized use of the DPS. Example A3 may also include the features of Example A2.

Example A4 includes the features of Example A1, and the multiple factors pertaining to the DPS further comprise policy data that associates a predetermined location with a predetermined list of one or more components of the DPS to be disabled while the DPS is in the predetermined location. Example A4 may also include the features of any one or more of Examples A2 through A3.

Example A5 includes the features of Example A1, and the multiple factors pertaining to the DPS further comprise policy data that prescribes a first set of security restrictions for a first user of the DPS and a second set of security restrictions for a second user of the DPS. Example A5 may also include the features of any one or more of Examples A2 through A4.

Example A6 includes the features of Example A1, and the policy data links the first set of security restrictions for the first user with a predetermined location, and the policy data links the second set of security restrictions for the second user with the same predetermined location. Example A6 may also include the features of any one or more of Examples A2 through A5.

Example A7 includes the features of Example A1, and the multiple factors pertaining to the DPS further comprise policy data that prescribes a first set of security restrictions for the user of the DPS in a first location and a second set of security restrictions for the user in a second location. Example A7 may also include the features of any one or more of Examples A2 through A6.

Example A8 includes the features of Example A1, and the operations further comprise (a) using the short range wireless module to obtain original security configuration data from the security module of the DPS; (b) determining whether the DPS is entering or leaving a location associated with the tracking station, in response to detecting the DPS; (c) saving the original security configuration data, in response to determining that the DPS is entering the location associated with the tracking station; and (d) using the short range wireless module to send the original security configuration data back to the security module of the DPS, in response to determining that the DPS is leaving the location associated with the tracking station. Example A8 may also include the features of any one or more of Examples A2 through A7.

Example A9 includes the features of Example A1, and the operation of using the short range wireless module and the credentials to write the security configuration data to the secure storage in the security module of the DPS comprises using a wireless protocol other than WiFi to write the security configuration data to the secure storage of the DPS. Example A9 may also include the features of any one or more of Examples A2 through A8.

Example B is a premises-aware security system. The premises-aware security system comprises a tracking station according to Example A1. The premises-aware security system also comprises a mobile data processing system (DPS) comprising (a) a security orchestration agent which, when executed by the mobile DPS, executes within a trusted execution environment; (b) a security module with secure storage that is only accessible to authorized entities, wherein the secure storage can be read from wirelessly and written to wirelessly whether the mobile DPS is powered on or off; and (c) a device capabilities list stored in the security module, wherein the device capabilities list identifies one or more components of the mobile DPS that can be disabled by the security orchestration agent. The security module is operable to perform operations comprising (a) identifying the mobile DPS to the tracking station after the mobile DPS has entered a communication range of the tracking station; (b) sharing the device capabilities list with the tracking station; (c) receiving security configuration data from the tracking station after identifying the mobile DPS to the tracking station and sharing the device capabilities list with the tracking station, wherein the security configuration data identifies at least one component of the mobile DPS to be disabled or to be enabled; and (d) storing the security configuration data in the secure storage. The security orchestration agent is operable to automatically disable or enable one or more components of the mobile DPS, in accordance with the security configuration data, in response to the security configuration data being stored by the secure storage.

Example C1 is a method to support premises-aware security for data processing systems. The method comprises (a) detecting a data processing system (DPS) within communication range of a short range wireless module of a tracking station; (b) in response to detecting the DPS, using the short range wireless module to obtain identification data for the DPS from a security module of the DPS; (c) using the identification data to obtain credentials to access secure storage on the DPS; (d) after obtaining the identification data, automatically generating security configuration data for the DPS, based on multiple factors pertaining to the DPS, wherein the multiple factors comprise identity of the DPS, a location of the DPS, and at least one factor from the group consisting of: (i) capabilities of the DPS; (ii) identity of a user of the DPS; and (iii) a time factor; and (e) using the short range wireless module and the credentials to write the security configuration data to the secure storage of the DPS, wherein the security configuration data calls for the DPS to automatically disable or enable at least one component of the DPS.

Example C2 includes the features of Example C1, and the method further comprises using the credentials to read a device capabilities list for the DPS from the secure storage before automatically generating security configuration data for the DPS.

Example C3 includes the features of Example C1, and the method further comprises using the credentials to read a device capabilities list for the DPS from the secure storage before automatically generating security configuration data for the DPS. Example C3 may also include the features of Example C2.

Example C4 includes the features of Example C1, and the method further comprises (a) when a person is leaving a secure zone with the DPS, automatically determining who is leaving with the DPS, based on information from a device other than the DPS; (b) automatically determining whether the person leaving with the DPS is an authorized user of the DPS; and (c) in response to a determination that the person leaving with the DPS is not an authorized user of the DPS, automatically taking remedial measures to deter unauthorized use of the DPS. Example C4 may also include the features of any one or more of Examples C2 through C3.

Example C5 includes the features of Example C1, and the multiple factors pertaining to the DPS further comprise policy data that associates a predetermined location with a predetermined list of one or more components of the DPS to be disabled or to be enabled while the DPS is in the predetermined location. Example C5 may also include the features of any one or more of Examples C2 through C4.

Example C6 includes the features of Example C1, and the multiple factors pertaining to the DPS further comprise policy data that prescribes a first set of security restrictions for a first user of the DPS and a second set of security restrictions for a second user of the DPS. Example C6 may also include the features of any one or more of Examples C2 through C5.

Example C7 includes the features of Example C6, and the policy data links the first set of security restrictions for the first user with a predetermined location, and the policy data links the second set of security restrictions for the second user with the same predetermined location. Example C7 may also include the features of any one or more of Examples C2 through C5.

Example C8 includes the features of Example C1, and the multiple factors pertaining to the DPS further comprise policy data that prescribes a first set of security restrictions for the user of the DPS in a first location and a second set of security restrictions for the user in a second location. Example C8 may also include the features of any one or more of Examples C2 through C7.

Example C9 includes the features of Example C1, and the method further comprises (a) using the short range wireless module to obtain original security configuration data from the security module of the DPS; (b) determining whether the DPS is entering or leaving a location associated with the tracking station, in response to detecting the DPS; (c) saving the original security configuration data, in response to determining that the DPS is entering the location associated with the tracking station; and (d) using the short range wireless module to send the original security configuration data back to the security module of the DPS, in response to determining that the DPS is leaving the location associated with the tracking station. Example C9 may also include the features of any one or more of Examples C2 through C8.

Example C10 includes the features of Example C1, and the operation of using the short range wireless module and the credentials to write the security configuration data to the secure storage in the security module of the DPS comprises using a wireless protocol other than WiFi to write the security configuration data to the secure storage of the DPS. Example C10 may also include the features of any one or more of Examples C2 through C9.

Example D1 is a method for supporting premises-aware security. The method comprises (a) creating a trusted execution environment within a data processing system (DPS); (b) executing a security orchestration agent within the trusted execution environment; (c) after the DPS has entered a communication range of a short range wireless module of a tracking station, using a short range wireless protocol to identify the DPS to the tracking station and to share a device capabilities list from the security module with the tracking station, wherein the device capabilities list identifies one or more components of the DPS that can be disabled by the security orchestration agent; (d) after identifying the DPS to the tracking station and sharing the device capabilities list with the tracking station, receiving security configuration data from the tracking station via the short range wireless protocol, wherein the security configuration data identifies at least one component of the DPS to be disabled; (e) storing the security configuration data in secure storage of the security module, wherein the secure storage is only accessible to authorized entities, and wherein the secure storage can be read from wirelessly and written to wirelessly whether the DPS is powered on or off; and (f) automatically disabling one or more components of the DPS, in accordance with the security configuration data, in response to the security configuration data being stored in the secure storage of the security module. The operation of automatically disabling one or more components of the DPS is performed by the security orchestration agent. Also, the short range wireless protocol comprises a wireless protocol other than WiFi.

Example D2 includes the features of Example D1, and the security orchestration agent reads the security configuration data from the secure storage via a secure channel before automatically disabling one or more components of the DPS, in accordance with the security configuration data.

Example D3 includes the features of Example D1, and the security orchestration agent also identifies a current user of the DPS to the tracking station. Example D3 may also include the features of Example D2.

Example D4 includes the features of Example D1, and the security module performs operations comprising (a) determining whether the tracking station is an authorized entity; and (b) sharing the device capabilities list with the tracking station only if the tracking station is an authorized entity. Example D4 may also include the features of any one or more of Examples D2 through D3.

Example D5 includes the features of Example D1, and the method further comprises verifying integrity of the security orchestration agent before launching the security orchestration agent. Example D5 may also include the features of any one or more of Examples D2 through D4.

Example D6 includes the features of Example D1, and the method further comprises, after launching the security orchestration agent, periodically verifying integrity of the security orchestration agent. Example D6 may also include the features of any one or more of Examples D2 through D5.

Example D7 includes the features of Example D1, and the operation of automatically disabling one or more components of the DPS comprises (a) automatically disabling a hardware component and (b) automatically disabling a software component. Example D7 may also include the features of any one or more of Examples D2 through D6.

Example D8 includes the features of Example D1, and the operation of identifying the DPS to the tracking station comprises sharing an encrypted version of a unique identifier for the DPS with the tracking station, the encrypted version having been encrypted with a public key that corresponds to a private key held by the tracking station. Example D8 may also include the features of any one or more of Examples D2 through D7.

Example D9 includes the features of Example D1, and the short range wireless protocol comprises a radio frequency identification (RFID) protocol. Example D9 may also include the features of any one or more of Examples D2 through D8.

Example E is at least one machine accessible medium comprising computer instructions to support premises-aware security. The computer instructions, in response to being executed on a data processing system, enable the data processing system to perform a method according to any one or more of Examples C1 through C10 and D1 through D9.

Example F is a data processing system with support for premises-aware security. The data processing system comprises a processing element, at least one machine accessible medium responsive to the processing element, and computer instructions stored at least partially in the at least one machine accessible medium. Also, in response to being executed, the computer instructions enable the data processing system to perform a method according to any one or more of Examples C1 through C10 and D1 through D9.

Example G is a premises-aware security system comprising (a) a tracking station to perform a method according to any one or more of Examples C1 through C10, and (b) a mobile data processing system to perform a method according to any one or more of Examples D1 through D9.

Example H is a data processing system with support for premises-aware security. The data processing system comprises means for performing the method of any one or more of Examples C1 through C10 and D1 through D9.

Example I1 is an apparatus to support premises-aware security. The apparatus comprises a machine accessible medium and data in the machine accessible medium which, when accessed by a tracking station, enables the tracking station to perform various operations. Those operations comprise (a) detecting a mobile data processing system (DPS) within communication range of a short range wireless module of the tracking station; (b) in response to detecting the DPS, using the short range wireless module to obtain identification data for the DPS from a security module of the DPS; (c) using the identification data for the DPS to obtain credentials to access secure storage on the DPS; and (d) after obtaining the identification data from the security module, automatically generating security configuration data for the DPS, based on multiple factors pertaining to the DPS. The multiple factors comprise identity of the DPS, a location of the DPS, and at least one factor from the group consisting of (i) capabilities of the DPS, (ii) identity of a user of the DPS, and (iii) a time factor. The operations further comprise using the short range wireless module and the credentials to write the security configuration data to the secure storage in the security module of the DPS, wherein the security configuration data calls for the DPS to automatically disable or enable at least one component of the DPS.

Example I2 includes the features of Example I1, and the operations further comprise using the credentials to read a device capabilities list for the DPS from the secure storage before automatically generating security configuration data for the DPS. Also, the multiple factors pertaining to the DPS further comprise policy data that prescribes a first set of security restrictions for a first user of the DPS and a second set of security restrictions for a second user of the DPS. The policy data links the first set of security restrictions for the first user with a predetermined location. The policy data also links the second set of security restrictions for the second user with the same predetermined location.

Example J1 is a data processing system with support for premises-aware security. The data processing system comprises (a) a security orchestration agent which, when executed by the data processing system (DPS), executes within a trusted execution environment; (b) a security module with secure storage that is only accessible to authorized entities, wherein the secure storage can be read from wirelessly and written to wirelessly whether the DPS is powered on or off; and (c) a device capabilities list stored in the security module, wherein the device capabilities list identifies one or more components of the DPS that can be disabled by the security orchestration agent. The security module is operable to perform operations comprising (d) identifying the DPS to a tracking station after the DPS has entered a communication range of the tracking station; (e) sharing the device capabilities list with the tracking station; (f) receiving security configuration data from the tracking station after identifying the DPS to the tracking station and sharing the device capabilities list with the tracking station, wherein the security configuration data identifies at least one component of the DPS to be disabled; and (g) storing the security configuration data in the secure storage. The security orchestration agent is operable to automatically disable one or more components of the DPS, in accordance with the security configuration data, in response to the security configuration data being stored by the secure storage.

Example J2 includes the features of Example J1, and the security orchestration agent is operable to read the security configuration data from the secure storage via a secure channel.

Example J3 includes the features of Example J1, and the security module is also operable to identify a current user of the DPS to the tracking station. Example J3 may also include the features of Example J2.

Example J4 includes the features of Example J3, and the security module is operable to perform further operations comprising (a) determining whether the tracking station is an authorized entity, and (b) sharing the device capabilities list with the tracking station only if the tracking station is an authorized entity. Example J4 may also include the features of Example J2.

Example J5 includes the features of Example J1, and the data processing system further comprises a loader which, when executed, verifies integrity of the security orchestration agent before launching the security orchestration agent. Example J5 may also include the features of any one or more of Examples J2 through J5.

Example J6 includes the features of Example J1, and the data processing system further comprises a security agent which, when executed, periodically verifies integrity of the security orchestration agent. Example J6 may also include the features of any one or more of Examples J2 through J6.

Example J7 includes the features of Example J1, and the security module comprises a radio frequency identification (RFID) module. Example J7 may also include the features of any one or more of Examples J2 through J6.

Example J8 includes the features of Example J1, and the security orchestration agent is operable to automatically disable hardware components and software components. Example J8 may also include the features of any one or more of Examples J2 through J7.

Example J9 includes the features of Example J1, and the security module comprises an encrypted version of a unique identifier for the DPS, the encrypted version having been encrypted with a public key that corresponds to a private key held by the tracking station. Also, the operation of identifying the DPS to the tracking station comprises sharing the encrypted version of the unique identifier for the DPS with the tracking station. Example J9 may also include the features of any one or more of Examples J2 through J8.

Example J10 includes the features of Example J1, and the device capabilities list also identifies one or more components that can be enabled by the security orchestration agent. The security configuration data identifies at least one component to be enabled, and the security orchestration agent is operable to automatically enable one or more components of the DPS, in accordance with the security configuration data, in response to the security configuration data being stored by the secure storage. Example J10 may also include the features of any one or more of Examples J2 through J9.

What is claimed is:

1. A tracking station to support premises-aware security, the tracking station comprising:
at least one processor;
a short range wireless module in communication with the processor; and
instructions which, when executed by the processor, enable the tracking station to perform operations comprising:
detecting a data processing system (DPS) within communication range of the short range wireless module;
in response to detecting the DPS, using the short range wireless module to obtain identification data for the DPS from a security module of the DPS;
using the identification data for the DPS to obtain credentials to access secure storage in the security module of the DPS;
after obtaining the identification data from the security module, automatically generating security configuration data for the DPS, based on multiple factors pertaining to the DPS, wherein the multiple factors comprise identity of the DPS, a location of the DPS, and at least one factor from the group consisting of:
capabilities of the DPS;
identity of a user of the DPS; and
a time factor; and
using the short range wireless module and the credentials to write the security configuration data to the secure storage in the security module of the DPS, wherein the security configuration data calls for the DPS to automatically perform at least one operation from the group consisting of:
disabling at least one component of the DPS; and
enabling at least one component of the DPS.

2. A tracking station according to claim 1, wherein the operations further comprise:
using the credentials to read a device capabilities list for the DPS from the secure storage before automatically generating security configuration data for the DPS.

3. A tracking station according to claim 1, wherein the operations further comprise:
when a person is leaving a secure zone with the DPS, automatically determining who is leaving with the DPS, based on information from a device other than the DPS;
automatically determining whether the person leaving with the DPS is an authorized user of the DPS; and
in response to a determination that the person leaving with the DPS is not an authorized user of the DPS, automatically taking remedial measures to deter unauthorized use of the DPS.

4. A tracking station according to claim 1, wherein the multiple factors pertaining to the DPS further comprise policy data that associates a predetermined location with a predetermined list of one or more components of the DPS to be disabled while the DPS is in the predetermined location.

5. A tracking station according to claim 1, wherein the multiple factors pertaining to the DPS further comprise policy data that prescribes a first set of security restrictions for a first user of the DPS and a second set of security restrictions for a second user of the DPS.

6. A tracking station according to claim 5, wherein the policy data links the first set of security restrictions for the first user with a predetermined location, and the policy data links the second set of security restrictions for the second user with the same predetermined location.

7. A tracking station according to claim 1, wherein the multiple factors pertaining to the DPS further comprise policy data that prescribes a first set of security restrictions for the user of the DPS in a first location and a second set of security restrictions for the user in a second location.

8. A tracking station according to claim 1, wherein the operations further comprise:
using the short range wireless module to obtain original security configuration data from the security module of the DPS;
determining whether the DPS is entering or leaving a location associated with the tracking station, in response to detecting the DPS;
saving the original security configuration data, in response to determining that the DPS is entering the location associated with the tracking station; and
using the short range wireless module to send the original security configuration data back to the security module of the DPS, in response to determining that the DPS is leaving the location associated with the tracking station.

9. A tracking station according to claim 1, wherein the operation of using the short range wireless module and the credentials to write the security configuration data to the secure storage in the security module of the DPS comprises:
using a wireless protocol other than WiFi to write the security configuration data to the secure storage of the DPS.

10. A premises-aware security system comprising:
a tracking station according to claim 1; and
a mobile data processing system (DPS) comprising:
a security orchestration agent which, when executed by the mobile DPS, executes within a trusted execution environment;
a security module with secure storage that is only accessible to authorized entities, wherein the secure storage can be read from wirelessly and written to wirelessly whether the mobile DPS is powered on or off; and
a device capabilities list stored in the security module, wherein the device capabilities list identifies one or more components of the mobile DPS that can be disabled by the security orchestration agent;
wherein the security module is operable to perform operations comprising:
identifying the mobile DPS to the tracking station after the mobile DPS has entered a communication range of the tracking station;
sharing the device capabilities list with the tracking station;
receiving security configuration data from the tracking station after identifying the mobile DPS to the tracking station and sharing the device capabilities list with the tracking station, wherein the security configuration data identifies at least one component of the mobile DPS to be disabled or to be enabled; and
storing the security configuration data in the secure storage; and
wherein the security orchestration agent is operable to automatically disable or enable one or more components of the mobile DPS, in accordance with the security configuration data, in response to the security configuration data being stored by the secure storage.

11. A method to support premises-aware security for data processing systems, comprising:
detecting a data processing system (DPS) within communication range of a short range wireless module of a tracking station;
in response to detecting the DPS, using the short range wireless module to obtain identification data for the DPS from a security module of the DPS;
using the identification data to obtain credentials to access secure storage on the DPS;
after obtaining the identification data, automatically generating security configuration data for the DPS, based on multiple factors pertaining to the DPS, wherein the multiple factors comprise identity of the DPS, a location of the DPS, and at least one factor from the group consisting of: (a) capabilities of the DPS; (b) identity of a user of the DPS; and (c) a time factor; and
using the short range wireless module and the credentials to write the security configuration data to the secure storage of the DPS, wherein the security configuration data calls for the DPS to automatically disable or enable at least one component of the DPS.

12. A method according to claim 11, further comprising:
using the credentials to read a device capabilities list for the DPS from the secure storage before automatically generating security configuration data for the DPS.

13. A method according to claim 11, further comprising:
when a person is leaving a secure zone with the DPS, automatically determining who is leaving with the DPS, based on information from a device other than the DPS;
automatically determining whether the person leaving with the DPS is an authorized user of the DPS; and
in response to a determination that the person leaving with the DPS is not an authorized user of the DPS, automatically taking remedial measures to deter unauthorized use of the DPS.

14. A method according to claim 11, wherein the multiple factors pertaining to the DPS further comprise policy data that prescribes a first set of security restrictions for a first user of the DPS and a second set of security restrictions for a second user of the DPS.

15. An apparatus to support premises-aware security, the apparatus comprising:
a machine accessible medium; and
data in the machine accessible medium which, when accessed by a tracking station, enables the tracking station to perform operations comprising:
detecting a data processing system (DPS) within communication range of a short range wireless module of the tracking station;
in response to detecting the DPS, using the short range wireless module to obtain identification data for the DPS from a security module of the DPS;
using the identification data to obtain credentials to access secure storage on the DPS;
after obtaining the identification data, automatically generating security configuration data for the DPS, based on multiple factors pertaining to the DPS, wherein the multiple factors comprise identity of the DPS, a location of the DPS, and at least one factor from the group consisting of:
capabilities of the DPS;
identity of a user of the DPS; and
a time factor; and
using the short range wireless module and the credentials to write the security configuration data to the secure storage of the DPS, wherein the security configuration data calls for the DPS to automatically disable or enable at least one component of the DPS.

16. An apparatus according to claim 15, wherein:
the operations further comprise using the credentials to read a device capabilities list for the DPS from the secure storage before automatically generating security configuration data for the DPS;
the multiple factors pertaining to the DPS further comprise policy data that prescribes a first set of security restrictions for a first user of the DPS and a second set of security restrictions for a second user of the DPS;
the policy data links the first set of security restrictions for the first user with a predetermined location; and
the policy data links the second set of security restrictions for the second user with the same predetermined location.

17. A data processing system with support for premises-aware security, the data processing system comprising:
a security orchestration agent which, when executed by the data processing system (DPS), executes within a trusted execution environment;
a security module with secure storage that is only accessible to authorized entities, wherein the secure storage can be read from wirelessly and written to wirelessly whether the DPS is powered on or off; and
a device capabilities list stored in the security module, wherein the device capabilities list identifies one or more components of the DPS that can be disabled by the security orchestration agent;
wherein the security module is operable to perform operations comprising:
identifying the DPS to a tracking station after the DPS has entered a communication range of the tracking station;
sharing the device capabilities list with the tracking station;
receiving security configuration data from the tracking station after identifying the DPS to the tracking station and sharing the device capabilities list with the tracking station, wherein the security configuration data identifies at least one component of the DPS to be disabled; and
storing the security configuration data in the secure storage; and
wherein the security orchestration agent is operable to automatically disable one or more components of the DPS, in accordance with the security configuration data, in response to the security configuration data being stored by the secure storage.

18. A data processing system according to claim 17, wherein the security orchestration agent is operable to read the security configuration data from the secure storage via a secure channel.

19. A data processing system according to claim 17, wherein the security module is operable to perform further operations comprising:
determining whether the tracking station is an authorized entity; and
sharing the device capabilities list with the tracking station only if the tracking station is an authorized entity.

20. A data processing system according to claim 17, further comprising a loader which, when executed, verifies integrity of the security orchestration agent before launching the security orchestration agent.

21. A data processing system according to claim 17, further comprising a security agent which, when executed, periodically verifies integrity of the security orchestration agent.

22. A data processing system according to claim 17, wherein the security module comprises a radio frequency identification (RFID) module.

23. A data processing system according to claim 17, wherein the security orchestration agent is operable to automatically disable hardware components and software components.

24. A data processing system according to claim 17, wherein:
the security modules comprises an encrypted version of a unique identifier for the DPS, the encrypted version having been encrypted with a public key that corresponds to a private key held by the tracking station; and
the operation of identifying the DPS to the tracking station comprises sharing the encrypted version of the unique identifier for the DPS with the tracking station.

25. A data processing system according to claim 17, wherein:
the device capabilities list also identifies one or more components that can be enabled by the security orchestration agent;
the security configuration data identifies at least one component to be enabled; and
the security orchestration agent is operable to automatically enable one or more components of the DPS, in accordance with the security configuration data, in response to the security configuration data being stored by the secure storage.
